(19) United States
(12) Patent Application Publication
(10) Pub. No.: US 2026/0120986 A1
(43) Pub. Date: Apr. 30, 2026

(54) HIGH VOLTAGE CIRCUIT-BREAKER

(71) Applicant: Hitachi Energy Ltd, Zürich (CH)

(72) Inventors: Christoph Wirth, Pfungen (CH); Lukasz Ziomka, Zürich (CH); Mahesh Dhotre, Brugg (CH)

(21) Appl. No.: 19/165,193

(22) PCT Filed: Mar. 14, 2024
(86) PCT No.: PCT/EP2024/056856

§ 371 Date: Sep. 15, 2025

(30) Foreign Application Priority Data
Mar. 16, 2023 (EP) 23162365.3

(51) Int. Cl. H01H 33/90; H01H 33/02; H01H 33/70; H01H 33/91

(52) U.S. Cl. CPC H01H 33/905; H01H 33/7084; H01H 33/903; H01H 33/91; H01H 2033/028; H01H 2033/907

(57) ABSTRACT

The disclosure relates to a circuit-breaker for high-voltage applications including at least one making and breaking unit having a first contact and a second contact for forming an electrically conductive connection in a connection region, wherein the first contact has an outlet arranged distant to the connection region for insulating gas passing the connection region and through the first contact and wherein the first contact is movable along an axially extending switching axis of the circuit-breaker over a moving distance between a closed position where the electrically conductive connection is formed and an open position where the electrically conductive connection is separated; a gas compression cylinder that is motion-coupled to the first contact and which defines a cylinder volume for the insulating gas, wherein the cylinder volume is variable by means of a piston sliding in the gas compression cylinder when moving the first contact.

### CROSS REFERENCE TO RELATED APPLICATIONS

This application is a 35 U.S. C. § 371 national stage application of International Application No. PCT/EP2024/056856 filed on Mar. 14, 2024, which in turn claims foreign priority to European Patent Application No. 23162365.3 filed on Mar. 16, 2023, the disclosures and content of which are incorporated by reference herein in their entirety.

### TECHNICAL FIELD

The disclosure relates to a circuit-breaker for high-voltage applications comprising at least one making and breaking unit having a first contact and a second contact for forming an electrically conductive connection in a connection region, wherein at least one contact has an outlet for insulating gas passing the connection region and is movable along an axially extending switching axis of the high voltage circuit-breaker between a closed position where the electrically conductive connection is formed and an open position where the electrically conductive connection is separated; and comprising a gas compression cylinder that is motion-coupled to the first contact and which defines a cylinder volume for the insulating gas that is variable when moving the first contact.

### BACKGROUND ART

In high current test duty, there may be an interaction of a pressure build-up in the cylinder volume and a force that moves the movable contact, which determines the contact travel. Such interaction can physically slow or reverse the contact movement (here onwards, referred to as the back-travel) depending upon generated pressure build-up. Back travel causes increase in the local electrical field as contact come closer. As result, the circuit-breaker may experience late restrikes or dielectric failure. In the worst case it can lead to the complete re-close of the circuit-breaker. Since the back travel is undefined, design measures cannot be taken to avoid the failure.

To limit the back travel or stalling of the contacts, one can use stronger drive or force to move the movable contact, which needs higher energy that means higher cost, or one must use mechanical back travel limiter, which introduces additional moving parts and another problem with particle generation, mechanical reliability etc. It is difficult to find the optimal combination of drive energy (lower) and pressure build-up (higher). The present disclosure aims at reducing the necessitated drive energy or force and at same time preferably limiting the back travel.

### SUMMARY

It is therefore an object of the disclosure to provide a high voltage circuit-breaker having improved ability to economically interrupt high-voltage connections.

The object of the disclosure is solved by the features of the independent claims. Preferred implementations are detailed in the dependent claims.

Thus, the object is solved by a circuit-breaker for high-voltage applications comprising
at least one making and breaking unit having a first contact and a second contact for forming an electrically conductive connection in a connection region, wherein the first contact has an outlet arranged and/or ending distant to the connection region for insulating gas passing the connection region and through the first contact and wherein the first contact is movable along an axially extending switching axis of the circuit-breaker over a moving distance between a closed position where the electrically conductive connection is formed and an open position where the electrically conductive connection is separated;
a gas compression cylinder that is motion-coupled to the first contact and which defines a cylinder volume for the insulating gas, wherein the cylinder volume is variable by means of a piston sliding in the gas compression cylinder when moving the first contact, and wherein the gas compression cylinder comprises a passage extending between the cylinder volume and the connection region; and
an exhaust for receiving the insulating gas through the outlet, defining an exhaust volume for received insulating gas, wherein the cylinder volume is variable by means of a plunger motion-coupled to the first contact,
wherein the exhaust is designed to increase the exhaust volume based on a separation movement of the first contact and the gas compression cylinder is designed to decrease the cylinder volume based on the separation movement of the first contact;
wherein another outlet of the exhaust for insulating gas passing the exhaust volume and/or the outlet are/is blocked at least in the closed position by means of the exhaust;
wherein the first contact can assume a first interim position between the open and the closed position, wherein in the first interim position the outlet is fluidly connected to the exhaust volume; and
wherein the first contact can assume a second interim position between the first interim position and the open position where the another outlet fluidly connects the exhaust volume with another volume of the circuit-breaker and/or where the outlet is fluidly connected to the exhaust volume.

The circuit-breaker may comprise a housing defining a volume for the insulating gas, particularly wherein the at least one making a breaking unit and/or the gas compression cylinder and/or the exhaust may be arranged in the housing. Preferably, the gas compression cylinder may be designed to decrease the cylinder volume based on a separation movement of the first contact, particularly wherein the first contact element is moved in a direction from the closed to the open position, e.g. to compress the gas and push the gas e.g. through the passage, via the connection region, and through the outlet. There may be a channel in the first contact which may extend from the connection region particularly at least partially and/or essentially along the switching axis. The outlet may be in the form of a plurality of outlets and/or there may be more than one outlet. For example, there may be two, three or more outlets on the first contact.

The proposed solution is based on the idea having two compartments on the moving contact side which change their size in opposite ways upon separating the connection with the help of an axial separational force pulling at the first contact with the circuit-breaker particularly adopting a combination with at least one of the outlet or the exhaust being closed when the circuit-breaker is in its closed position to stop the insulating gas, and with at least one of the outlet or the exhaust providing a fluid connection for the insulating gas when the circuit-breaker is in a position different to the closed position (e.g. first or second interim position and/or open position), preferably when being moved towards the open position, so that the insulating gas can flow. A force acting against the separational force coming from the pressure build-up in the first compartment or cylinder volume can be partially compensated/reduced by the second compartment or exhaust volume at least partially receiving the built-up pressure, particularly as a function of having at least one of the outlets to be open when not in the closed position. The force caused by such an another pressure build-up in the second compartment or exhaust volume may inherently act towards the same direction as the separational force does. This is because the exhaust volume particularly increases upon separating the contacts and receives the insulating gas through the outlet of the moving first contact. Particularly, since there may not only be a pressure build-up from compression in the first compartment or cylinder volume, but since there may also be an arc-generated pressure build-up in the cylinder volume typically acting towards the second compartment or the exhaust volume and/or the outlet, such pressure may be used to reduce the separational force overall needed.

The disclosure provides that the outlet and the further outlet may open one after the other along the path of movement of the first contact towards the open position, e.g. the outlet opens in the first interim position and the further outlet opens in the second interim position, wherein both outlet and further outlet are open in the open position.

In other words the idea is to have two volumes which are variable based on a motion-coupling in combination with cylinder-piston-mechanisms when the switch is moved between the open and the closed position in order to move insulating gas via or through an outlet of the moving contact from the first volume to the second volume, and including a clever arrangement of the opening and/or another opening for the insulating gas to have a beneficial use of a pressure change in the volumes that is affected by the choice of the positions. When moving from closed to open positions, i.e. leaving the closed position by moving the first contact towards the open position, in the first volume the insulating gas may be compressed and a resistance builds up therein. The other volume which is meant to receive said insulating gas however increases in size and thus may serve at some point when a fluid connection is given to act against said resistance and/or reduces a necessary force. Particularly when an arc is present upon interruption, the pressure even increases so that this pressure may act in the second volume to support the separational force and thus push further towards the open position and/or at least reducing back-travel. At some point, e.g. when the second interim position or another position is reached, a pressure compensation at the second volume (i.e. exhaust volume) is enabled through a fluid connection, especially to the first volume (i.e. cylinder volume) and/or to another volume of the circuit-breaker.

The housing is preferably provided gas-tight and/or comprises a tube-like or cylinder like form extending along the switching axis. The first contact and/or the second contact preferably extend along the switching axis. The second contact can be fixed relative to the housing and/or can be arranged movable along the switching axis. The term motion-coupled means that if the first contact is moved e.g. by a drive device, the gas compression cylinder, a cylinder element, the plunger, and/or the like is/are moved together at least in a translatoric manner, preferably with the same or similar kinematic properties, speed, acceleration and/or jerk, e.g. in parallel.

The making and breaking unit can be provided as interrupter. The gas compression cylinder and the exhaust are preferably associated and/or arranged at the at least one making and breaking unit and/or arranged distant to each other.

The moving distance is preferably at least the distance between a state when the first contact and the second contact form the electrically conductive connection and another state when said contact elements do not form such electrically conductive connection. The moving distance may be between 10 and 500 mm, particularly between 100 and 300 mm.

A damping means may be provided to dampen the movement, particularly of the first contact, particularly which is built to provide a damping force acting and/or increasing along the switching axis, especially as a function of moving distance, stroke, acceleration, speed, jerk and/or similar of the first contact. The term damping the movement of the first contact with a damping force increasing in relation to the moving distance means in particular that the damping force increases with the moving distance, for example may be low or even zero at the beginning when the first contact and the second contact still form the electrically conductive connection, preferably at zero or minimum moving distance, and may be highest when first contact and the second contact do not form the electrically conductive connection anymore, preferably at maximum moving distance.

The term high voltage relates to voltages that exceeds 1 kV. A high voltage preferably concerns nominal voltages in the range from above 72 kV to 800 kV, like 145 kV, 245 kV or 420 kV. The high voltage circuit-breaker may be provided as a circuit breaker and/or may include one or more components such as, a puffer-type cylinder, a self-blast chamber, a pressure collecting space, a compression space, or puffer volume, and an expansion space. The high voltage circuit-breaker may effectuate interruption of the conductive connections by means of one or more of such components, thereby discontinuing flow of electrical current in the conductive connections, and/or extinction of the arc produced when the conductive connections is interrupted. The term “axial” designates an extension, distance etc. in the direction of the axis. An axial separation between parts means that these parts are separated from each other when seen or measured in the direction of the axis. The term “radial” designates an extension, distance etc. in a direction perpendicular to the axis. The term “cross-section” means a plane perpendicular to the axis, and the term “cross-sectional area” means an area in such a plane. The axis is presently the switching axis.

The insulating gas and/or dielectric insulation medium can be any suitable gas that enables to adequately extinguish the electric arc formed between the contact elements during a current interruption operation, such as, but not limited, to an inert gas as, for example, sulphur hexafluoride SF6. Specifically, the insulating gas used can be SF6 gas or any other dielectric insulation medium and/or insulating gas, may it be gaseous and/or liquid, and in particular can be a dielectric insulation gas or arc quenching gas. Such dielectric insulation medium and/or insulating gas can for example encompass media comprising an organofluorine compound, such organofluorine compound being selected from the group consisting of: a fluoroether, an oxirane, a fluoroamine, a fluoroketone, a fluoroolefin, a fluoronitrile, and mixtures and/or decomposition products thereof. Herein, the terms “fluoroether”, “oxirane”, “fluoroamine”, “fluoroketone”, “fluoroolefin” and “fluoronitrile” refer to at least partially fluorinated compounds. In particular, the term “fluoroether” encompasses both hydrofluoroethers and perfluoroethers, the term “oxirane” encompasses both hydrofluorooxiranes and perfluorooxiranes, the term “fluoroamine” encompasses both hydrofluoroamines and perfluoroamines, the term “fluoroketone” encompasses both hydrofluoroketones and perfluoroketones, the term “fluoroolefin” encompasses both hydrofluoroolefins and perfluoroolefins, and the term “fluoronitrile” encompasses both hydrofluoronitriles and perfluoronitriles. It can thereby be preferred that the fluoroether, the oxirane, the fluoroamine and the fluoroketone are fully fluorinated, i.e. perfluorinated.

The insulating gas and/or dielectric insulation medium can be selected from the group consisting of: a hydrofluoroether, a perfluoroketone, a hydrofluoroolefin, a perfluoronitrile, and mixtures thereof. In particular, the term “fluoroketone” as used in the context of the present disclosure shall be interpreted broadly and shall encompass both fluoromonoketones and fluorodiketones or generally fluoropolyketones. Explicitly, more than a single carbonyl group flanked by carbon atoms may be present in the molecule. The term shall also encompass both saturated compounds and unsaturated compounds including double and/or triple bonds between carbon atoms. The at least partially fluorinated alkyl chain of the fluoroketones can be linear or branched and can optionally form a ring. The dielectric insulation medium and/or insulating gas may comprise at least one compound being a fluoromonoketone and/or comprising also heteroatoms incorporated into the carbon backbone of the molecules, such as at least one of: a nitrogen atom, oxygen atom and sulphur atom, replacing one or more carbon atoms. More preferably, the fluoromonoketone, in particular perfluoroketone, can have from 3 to 15 or from 4 to 12 carbon atoms and particularly from 5 to 9 carbon atoms. Most preferably, it may comprise exactly 5 carbon atoms and/or exactly 6 carbon atoms and/or exactly 7 carbon atoms and/or exactly 8 carbon atoms.

Further, the insulating gas and/or dielectric insulation medium may comprise at least one compound being a fluoroolefin selected from the group consisting of: hydrofluoroolefins (HFO) comprising at least three carbon atoms, hydrofluoroolefins (HFO) comprising exactly three carbon atoms, trans-1,3,3,3-tetrafluoro-1-propene (HFO-1234ze), 2,3,3,3-tetrafluoro-1-propene (HFO-1234yf), and mixtures thereof. The organofluorine compound can also be a fluoronitrile, in particular a perfluoronitrile. In particular, the organofluorine compound can be a fluoronitrile, specifically a perfluoronitrile, containing two carbon atoms, and/or three carbon atoms, and/or four carbon atoms. More particularly, the fluoronitrile can be a perfluoroalkylnitrile, specifically perfluoroacetonitrile, perfluoropropionitrile (C2F5CN) and/or perfluoro-butyronitrile (C3F7CN). Most particularly, the fluoronitrile can be perfluoroisobutyronitrile (according to the formula (CF3)2CFCN) and/or perfluoro-2-methoxypropanenitrile (according to formula CF3CF(OCF3)CN). Of these, perfluoroisobutyronitrile (i.e. 2,3,3,3-tetrafluoro-2-trifluoromethyl propanenitrile alias i-C3F7CN) is particularly preferred due to its low toxicity. The dielectric insulation medium and/or insulating gas can further comprise a background gas or carrier gas different from the organofluorine compound (in particular different from the fluoroether, the oxirane, the fluoroamine, the fluoroketone and the fluoroolefin) and can in embodiments be selected from the group consisting of: air, N2, O2, CO2, a noble gas, H2; NO2, NO, N2O; fluorocarbons and in particular perfluorocarbons, such as CF4; CF3I, SF6; and mixtures thereof. For example, the dielectric insulating gas can be CO2 in an embodiment.

The outlet or the outlets may be blocked at least in the closed position, preferably by means of the exhaust, especially by means of a surface of an exhaust housing, particularly the surface at least essentially extending in parallel to the switching axis and/or the outlet arranged on a side of the first contact. The outlet may be blocked in the sense of a valve or path that is closed or at least substantially closed. The exhaust housing, particularly the surface of the exhaust housing, may be annular and/or cylindrical and surrounding and/or facing the outlet(s) and/or the side of the first contact, e.g. in a radial inwards direction, e.g. in a particular position of the first contact, such as the closed position or at least when the first contact is close to the

When the outlet is blocked at least in the closed position and when the circuit-breaker is moved out of the closed position the pressure can increase in the connection region and the insulating gas cannot pass the outlet unless the blocking is removed. This provides the possibility to have a pressure increase in the cylinder volume and particularly not in the exhaust volume.

The first contact can assume the first interim position between the open and the closed position, wherein in the first interim position the outlet is or the outlets are fluidly connected to the exhaust volume. Particularly, in the first interim position the outlet is or the outlets are unblocked. In other words the outlet(s) may serve as a path for the insulating gas to enter the exhaust volume via the outlet or outlets, particularly coming from the cylinder volume and/or having passed the connection region, in the first interim position. In this position, the outlet(s) may not be blocked, e.g. contrary to the situation preferably present in the closed position. This can ensure that in the exhaust volume a pressure increase may occur which may result in an axial force acting on the first contact towards the open position. This can also ensure that in the exhaust volume only at a particular point the pressure increase is provided.

An another outlet of the exhaust or the another outlet of the exhaust may be blocked at least in the closed position, and preferably in a first interim position or in the first interim position, preferably by means of the exhaust, more preferably by a surface of the plunger, particularly said surface at least essentially extending in parallel to the switching axis. There may be more than one another outlet, e.g. a plurality thereof, such as two, three or more another outlets. Another outlets may be provided at the exhaust circumferentially distributed. The another outlet(s) may be closed and/or blocked unless a certain position of the first contact has been reached upon separating the contacts. The another outlet(s) may assure that the exhaust volume is—aside from the outlet(s)—substantially fluid tight to the outside and/or the volume in the housing and/or another outlet. The another outlet(s) may be blocked in the sense of a valve or path that is closed or at least substantially closed. The surface of the plunger may be annular and/or cylindrical and surrounding and/or facing the another outlet(s), e.g. in a radial outwards direction, e.g. in a particular position of the first contact, such as the closed position or the first interim position or at least when the first contact is close to the closed position. This ensures that the pressure can increase in the exhaust volume and that the insulating gas cannot pass the another outlet(s) unless the blocking is removed and/or the another outlet(s) is/are opened.

The second interim position may be between the closed position and the open position. The second interim position is between the first interim position and the open position. The first contact can assume the second interim position, at which second interim position the outlet is fluidly connected to the exhaust volume and particularly is unblocked, and/ at which second interim position (the) another outlet(s) fluidly connect(s) the exhaust volume with another volume of the circuit-breaker and particularly is unblocked. In other words the outlets(s) and/or the another outlet(s) may serve as a path for the insulating gas to leave, particularly coming from the cylinder volume and/or having passed the connection region, in the second interim position. In this position, the another outlet(s) may not be blocked, e.g. contrary to the situation preferably present in the closed position and the first interim position. This can ensure that in the exhaust volume a pressure decrease may occur towards finishing the separation of the contacts.

Particularly the moving distance and/or stroke of the first contact between the closed position and the first interim position is between 1 and 400 mm or 1 and 200 mm, more particularly between 5 and 150 mm. The first contact may be movable between the closed position and the first interim position by at least 1 mm or 5 mm and/or by up to 400, 200 or 150 or 50 mm. As such, the outlet(s) may be blocked unless the first contact is moved out of the closed position by at least 1 mm or 5 mm and/or by up to 400, 200 or 150 or 50 mm and/or reaches the first interim position.

The moving distance and/or stroke of the first contact while being in the first interim position is preferably between 1 and 100 mm or 1 and 50 mm. The first contact may be movable in the first interim position by at least 1 mm and/or by up to 100 mm or 50 mm. As such, the outlet(s) may be unblocked and/or the another outlet(s) may be blocked unless the first contact is moved out of the first interim position by at least 1 mm and/or by up to 50 or 100 mm and/or reaches the second interim position.

The moving distance and/or stroke of the first contact between the first interim position and the second interim position may be between 1 and 400 mm or 1 and 200 mm, particularly between 5 and 150 mm. The first contact may be movable between the first interim position and the second interim position by at least 1 or 5 mm and/or by up to 400, 200 or 150 mm. As such, the another outlet(s) may be blocked unless the first contact is moved out of the first interim position by at least 1 or 5 mm and/or by up to 400, 200 or 150 mm and/or reaches the second interim position.

The moving distance and/or stroke of the first contact between the second interim position and the open position may be between 1 and 400 mm or 1 and 200 mm, particularly between 5 and 150 mm. The moving distance of the first contact while being in the open position is between 1 and 100 mm or 1 and 50 mm. The first contact may be movable between the second interim position and the open position by at least 1 or 5 mm and/or by up to 400, 200 or 150 mm. As such, a gap between the exhaust housing and the plunger and/or the first contact may be blocked unless the first contact is moved out of the second interim position by at least 1 or 5 mm and/or by up to 400, 200 or 150 mm and/or reaches the open position.

The moving distance and/or stroke of the first contact between the closed position and the open position may be 400±40 mm or 200±20 mm or less.

The closed position may contain that the outlet is blocked, and preferably that the another outlet is blocked, for a pressure build-up in the exhaust volume during separation and/or upon leaving the closed position.

The first interim position may contain that the outlet is unblocked, and preferably that the another outlet is blocked, and preferably that the contacts are arranged at a distance to each other and/or form or have formed an arc, for a fluid communication between the cylinder volume and the exhaust volume and/or a generation of an axial support force by means of the exhaust during separation.

The second interim position may contain that the outlet is unblocked and that the another outlet is unblocked, and preferably that the contacts are arranged at a distance to each other and/or form or have formed an arc, for an overall pressure release during separation.

The open position may contain that the outlet is unblocked, that the another outlet is unblocked, and preferably that a gap is formed at the exhaust, and preferably that the contacts are arranged at a distance to each other and/or form or have formed an arc, for an overall pressure release during separation.

The gap may be formed between the first contact and the exhaust. The gap may be formed between the first contact and the exhaust housing, particularly between a/the plunger motion-coupled to the first contact and the exhaust housing. The gap may be formed between a surface or an edge of the exhaust, and between a surface or an edge of the first contact, particularly of the plunger.

The gap may be annular. The gap may be arranged substantially in parallel to and/or coaxial to the switching axis. The gap may be present in the open position. The gap particularly is not present and/or is blocked in the closed position, in the first interim position and/or in the second interim position. The circuit-breaker is especially configured to form and/or unblock the gap upon a movement towards the open position, preferably after or upon leaving the second interim position. As such, the gap provides a further path aside from the another outlet for the insulating gas to leave the circuit breaker. The gap is typically blocked unless the first contact is moved out of the second interim position towards the open position.

In another preferred implementation the exhaust volume is at least essentially smaller than the cylinder volume, particularly in at least one of said positions and/or by at least the factor of two, by one order of magnitude or more. The exhaust volume may be designed in its cross section smaller than the cylinder volume. This ensures that the pressure coming from the cylinder volume can be withstand mechanically by means of the exhaust with a construction substantially as rigid as the gas compression cylinder.

According to a further preferred implementation the exhaust is arranged distant to the connection region and/or opposite a face side of the first contact along the switching axis. The exhaust may be attached to and/or formed with one end of the first contact which is opposite the connection region. This helps to enable a compact construction. The exhaust can thus be easily motion-coupled to the first contact.

In another preferred implementation the exhaust housing is fixedly arranged relative to, motion-coupled and/or formed with the second contact, the piston and/or a housing of the circuit-breaker. At least two or all of the second contact, the piston and the housing may be motion-coupled. As such, moving the first contact may result in changing/varying in size both the cylinder volume and the exhaust volume, particularly in an interacting manner, e.g. decreasing the one while increasing the other.

In another preferred implementation the outlet and/or the another outlet are/is in the form of a radial hole and/or an oblong hole, particularly comprising a size in the range of 1 to 100 mm. The outlet and/or the another outlet (or the respective plurality) are preferably distributed circumferentially at the respective part, e.g. at the first contact and/or the exhaust housing. For example, the oblong hole may be elongated along the switching axis in order to vary the effective size as a function of the movement of the first contact.

In another preferred implementation the gas compression cylinder, particularly the cylinder element, and/or the exhaust, particularly the exhaust housing, at least partially surround(s) and/or is/are coaxial to the first contact to enable a compact size.

In another preferred implementation the first contact may have a channel extending from the connection region. The channel may extend along and/or in parallel to the switching axis. The outlet may extend from the channel to a/the side of the first contact. The outlet may be arranged distant to the connection region, particularly considered in a direction along or in parallel to the switching axis. The outlet is preferably shaped to be open at a/the face side of the first contact, most preferably via the channel. The channel may be in the form of an axial bore in the first contact. The channel may end distant to the face side and/or the connection region, while preferably being open sideways via the outlet(s). The channel particularly serves to guide insulating gas between outlet(s) and connection region. The channel and the outlet(s) may be arranged in sequence to each other. It is an option that the outlet serves as a fluid connection, preferably a direct fluid connection, between the connection region and the exhaust volume.

In another preferred implementation the exhaust, particularly the exhaust housing, surrounds the plunger for the plunger to slide on a surface of the exhaust, particularly the surface facing towards a radial inner direction. The plunger may be formed to at least substantially seal at the surface of the exhaust. The plunger may be fixedly arranged relative to, motion-coupled and/or formed with the first contact in order to work in the manner of a syringe.

In another preferred implementation the second contact has the shape of a pin in order to be plugged into the first contact, particularly the outlet, the channel and/or a/the face side of the first contact. The electrical connection may thus run via an at least substantially circumferential and/or annular shaped contact surface between the first and the second contacts to minimize transition resistance. It may also be an option that the second contact at least substantially fluidly seals and/or blocks the channel and/or the outlet for an initial pressure increase in the cylinder volume upon interruption particularly starting in the closed position.

The first contact may comprise a contact means, such as a spring contact and/or contact sleeve preferably at the face side being contacted, preferably pushed back in a radial outwards direction, in the closed position by means of the second contact. The contact means may be elastically deformable. This increases surface area for the electrical connection.

The first contact and/or the second contact may be may of an alloy, preferably containing at least 25 or 50 wt.-% iron, copper, silver and/or gold and/or at least substantially consist thereof. The first contact and/or the second contact may be coated, e.g. with copper, silver and/or gold. This may be beneficial to the electrical properties and/or the sealing of the channel and/or the outlet at the connection region.

In another preferred implementation at the connection region a passage of the gas compression cylinder extending from the cylinder volume is oriented oblique to the switching axis. The passage may point towards and/or end in the connection region. The passage thus serves to guide insulating gas directly and at little aerodynamic losses to an arcing region.

In another preferred implementation the gas compression cylinder surrounds and slides on the piston, wherein the piston surrounds and slides on the first contact, and/or wherein the piston is fixedly arranged relative to, motion-coupled and/or formed with a/the housing of the circuit-breaker, the second contact, and/or the exhaust. The piston may be formed to at least substantially seal on a surface of the gas compression cylinder and on a surface of the first contact. The piston may be at least substantially fixedly arranged relative to, motion-coupled and/or formed with the housing and/or the exhaust housing in order to work in the manner of a syringe. The second contact may be movable separately in an opposite direction to the first contact's movability out of the closed position towards the open position.

The object is further solved by a method for building up support pressure in a circuit-breaker for high-voltage applications that is being moved from the closed to the open position, comprising the step of: compressing insulating gas in a/the cylinder volume and increasing an/the exhaust volume that is receiving the insulating gas having passed a/the connection region. The exhaust volume may not be in a fluid connection to the cylinder volume in the closed position, e.g. for the pressure in the cylinder volume to increase when the movement is being started. Said circuit-breaker may be the circuit-breaker described herein.

The method and the circuit-breaker allow for high opening speeds at little delays. The method and the circuit-breaker reduce required force for separation of the contacts, particularly reduces a required drive device power. The method and the circuit-breaker may arrange the contacts to be in contact to an electrical power source, e.g. a high-voltage power source, for the contacts to generate an arc during separation and for the insulating gas to support arc extinguishment.

In another preferred implementation the high voltage circuit-breaker comprises a gas damper for damping the movement of the first contact of the at least one making and breaking unit. According to a further preferred implementation the gas damper comprises a damping volume having a closed first end and a piston element configured for moving into the damping volume from a second end opposite to the first end. In another preferred implementation the first end is provided cup-like and/or tube-like with closed radially extending lateral surface.

The circuit-breaker may have a/the drive device particularly motion-coupled to the first contact and configured for moving the first contact. The drive device is preferably arranged at one end of the making and breaking unit and/or distant to the connection region and/or the second contact for a compact arrangement. The drive device may be configured to switch between at least two of the positions named herein. The drive device is preferably motorized and/or provided outside of the housing. In such implementation the drive device can be connected to the first contact element via a pull rod. The drive device may comprise an additional damper, which can be associated and/or integrated to the drive device.

Further implementations and advantages of the method are directly and unambiguously derived by the person skilled in the art from the high voltage circuit-breaker as described before.

### BRIEF DESCRIPTION OF DRAWINGS

These and other aspects of the disclosure will be apparent from and elucidated with reference to the implementations described hereinafter.

In the drawings:

FIG. 1 shows a circuit-breaker according to a preferred implementation in the closed

FIG. 2 shows the circuit-breaker in a first interim position in a cross-sectional schematic view,

FIG. 3 shows the circuit-breaker in a second interim position in a cross-sectional schematic view, and

FIG. 4 shows the circuit-breaker in an open position in a cross-sectional schematic view.

### DESCRIPTION OF IMPLEMENTATIONS

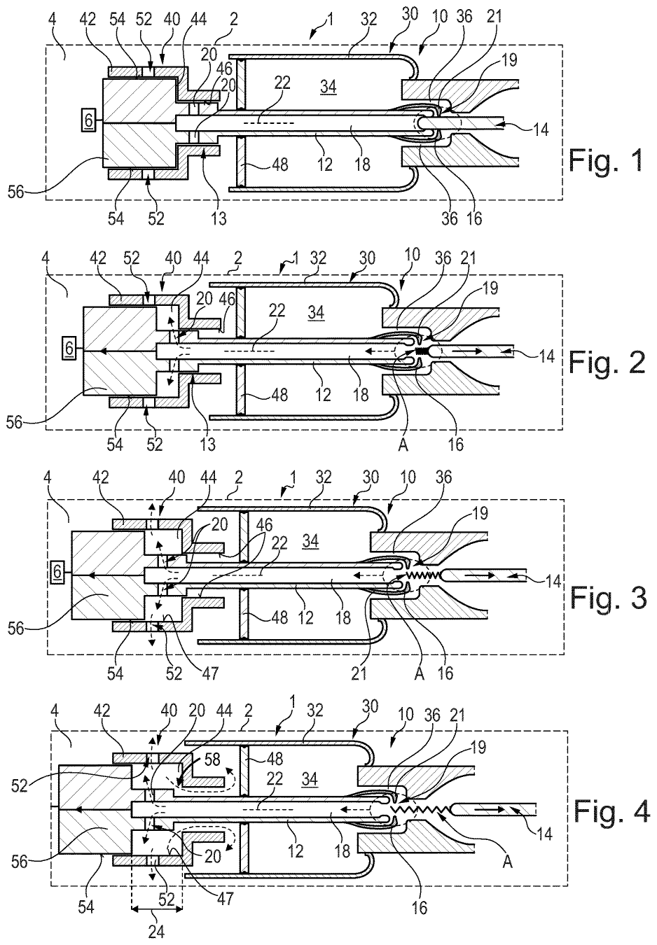

FIG. 1 shows a high voltage circuit-breaker 1 according to a preferred implementation in a cross-sectional schematic view.

The circuit-breaker 1 has a housing 2 that defines a volume 4 for an insulating gas.

A making and breaking unit 10 arranged in the housing 2 has a first contact 12 and a second contact 14 for forming an electrically conductive connection in a connection region 16. The first contact 12 has a channel 18 that is generally meant for the insulating gas to pass through and/or be guided thereby. The channel 18 extends from the connection region 16 to a plurality (e.g. 2, 3, 4, 5, 6 or more) of outlets 20 distributed circumferentially, the outlets 20 which are referred to as ‘the outlet 20’ in the following.

The outlet 20 is arranged distant to the connection region 16 and is meant for insulating gas passing or having passed the connection region 16, particularly being compressed insulating gas and/or having served to extinguish an arc A.

The flow direction of insulating gas is indicated in FIGS. 1 to 4 by means of dotted lines with arrows.

The channel 18 extends axially. The outlet 20 extends from the channel 18 to a side 13 of the first contact 12 distant to the connection region 16. Each outlet 20 is in the form of radial hole which is oblong along a switching axis 22 comprising a size in the range of 1 to 100 mm.

The first contact 12 is movable along the axially extending switching axis 22 over a moving distance 24 between a closed position which is shown in FIG. 1 where the electrically conductive connection is formed and an open position which is shown in FIG. 4 where the electrically conductive connection is separated. The second contact 14 is movable in substantially the opposite direction relative to the first contact 12 starting from the closed position as in FIG. 1 towards the open position as in FIG. 4.

The second contact 14 has the shape of a pin in order to be plugged into the first contact 12, particularly its channel 18, and/or a face side 19 thereof. Said pin at least substantially fluidly seals and/or blocks the channel 18 for an initial pressure increase in the cylinder volume 34 upon starting interruption in the closed position as shown in FIG. 1.

The first contact 12 has a contact means 21 in the form of an elastically deformable contact sleeve at the face side 19 being contacted in the closed position by means of the second contact 14, cf. FIG. 1.

At the connection region 16 a passage 36 extending from the cylinder volume 34 is oriented oblique to the switching axis 22, the second contact 14 and/or the channel 18 to have insulating gas cross an arc A obliquely.

Particularly, the passage 36 or a plurality thereof is/are arranged with respect to the axial direction 22 circumferentially, particularly distributed, at the face side 19 in order to surround the arc A.

A gas compression cylinder 30 arranged in the housing 2 is motion-coupled to the first contact 12 and defines a cylinder volume 34 for insulating gas. The cylinder volume 34 is variable by means of a piston 48 sliding in the gas compression cylinder 30, particularly its cylinder element 32. The piston 48 is designed to slide in the gas compression cylinder 30 when moving the first contact 12. Here, the gas compression cylinder 30 comprises the passage 36 extending between the cylinder volume 34 and the connection region 16. When the first contact 12 is moved (to the left in the Figs.) along the switching axis 22, the cylinder volume 34 is being varied, especially reduced, particularly to compress insulating gas therein.

It can be understood that the gas compression cylinder 30 comprises parts and means to enable the compression of insulating gas, such as the piston 48, the passage 36, the cylinder element 32, a housing and the like. The cylinder element 32 at least essentially relates to a cylindrically shaped body or shell.

An exhaust 40 arranged in the housing 2 and provided for receiving the insulating gas through the outlet 20 is placed distant to the connection region 16 and opposite the face side 19 of the first contact 12 along the switching axis 22. The exhaust 40 defines an exhaust volume 44 for insulating gas received from the outlet 20. The exhaust volume 44 is variable by means of a plunger 56 motion-coupled to the first contact 12. It is provided that the exhaust volume 44 is increased when the first contact 12 is moved out of the closed position in order to separate the connection, e.g. to the left along the switching axis 22 in FIGS. 1 to 4.

The exhaust 40 and/or the gas compression cylinder 30 is/are individually built to be variable linearly in contained volume upon a linear movement of the first contact 12. This is because the piston 48 and/or the plunger 56 both preferably can move sealingly on particularly cylindrical surfaces. It may be provided that there are extensional volumes that increase contained volume individually stepwise during the movement. Here, the piston 48 has sealing means and/or gaskets facing the inside of the cylinder element 32 and the outside of the first contact 12 in order to seal the volume 34. The plunger 56 may have a sealing means and/or gasket, but not necessarily.

The exhaust housing 42 is fixedly arranged relative to and/or motion-coupled to the piston 48 so that the first contact 12 can move relative thereto (or stand still with these parts) and together with the cylinder element 32 and the plunger 56. The exhaust housing 42 is also fixedly arranged relative to the housing 2.

Particularly, the cylinder element 32 at least essentially and/or partially surrounds and is arranged substantially coaxial to the first contact 12.

Particularly, the exhaust housing 42 at least essentially and/or partially surrounds and is arranged substantially coaxial to the first contact 12.

The exhaust housing 42 particularly surrounds the plunger 56 so that the plunger 56 slides with its surface 54 on a surface 47 of the exhaust housing 42. Here, the plunger 56 is fixedly arranged relative to and thus motion-coupled to the first contact 12.

The gas the cylinder element 32 surrounds and slides on the piston 48, wherein the piston 48 surrounds and slides on the first contact 12. The cylinder element 32 and the first contact 12 being motion-coupled makes the piston 48 being a movable lid to the cylinder volume 34 penetrated by the first contact 12 and acting as a forcer in the cylinder element 32. The piston 48 is fixedly arranged relative to and thus motion-coupled to the housing 2 and the exhaust housing 42.

Particularly, the primary path for the insulating gas to leave or enter the cylinder volume 34 is via the passage 36 and/or the connection region 16. Thus, in case the passage 36 or connection region 16 is directly or indirectly blocked, the pressure in the cylinder volume 34 can be decreased or increased via a movement of the piston 48 relative in the cylinder element 32. Then, insulating gas can be pushed out or sucked into the cylinder volume 34, particularly via the connection region 16, the face side 19 and the channel 18 to pass an arc A.

Here, the plunger 56, the first contact 12 and the cylinder element 32 are motion-coupled in order to be moved in parallel along the switching axis 22. A drive device 6 is motion-coupled to the first contact 12 and configured for moving the first contact 12. As such, when the closed position is being left by moving the first contact 12 towards an open position, the cylinder volume 34 is being decreased in size by means of the front end of the gas compression cylinder 30 moving towards the piston 48 which compresses contained insulating gas, and the exhaust volume 44 is being increased in size by means of the plunger 56 moving towards the back end of the exhaust 40, particularly an exhaust housing 42, and hence being retracted therefrom. As such, a method is performed where insulating gas is compressed in the cylinder volume 34 and the exhaust volume 44 receiving the insulating gas having passed the connection region 16 is increased.

Upon disconnecting/separating the contacts 12, 14, an arc A may be generated (cf. FIGS. 2-4) that even further increases the gas pressure in the volumes 34, 44 from high temperatures, the increased pressure thus partially acts towards the exhaust volume 44 effectively reducing the axial force necessary for the disconnecting/separational movement.

It may be, as indicated in the Figures, that the second contact 14 can be moved in an opposite direction relative to the first contact 12 to even more quickly separate the connection. In this sense, the first 12 and the second contact 14 may be motion-coupled by means of a gear and/or lever mechanism.

In FIG. 1 showing the closed position the outlet 20 is blocked by means of a surface 46 of the exhaust housing 42 of the exhaust 40. The surface 46 extends in parallel to the switching axis 22. The outlet 20 is arranged on the side 13 of the first contact 12. The surface 46 has a cylindrical shape and corresponds in diameter to the side 13 of the first contact 12. As such, insulating gas compressed in the cylinder volume 34 upon leaving the closed position cannot pass the outlet 20 yet due to the outlet 20 being blocked for a particular motion distance, e.g. in the range of 0.1 to 10, 25, or 50 mm measured from the closed position.

FIG. 2 shows a first interim position of the first contact 12 between the open and the closed position. Here, the outlet 20 is fluidly connected to the exhaust volume 44 and is unblocked. This is because the outlet 20 is at least partially retracted from the surface 46 of the exhaust 40. The outlet 20 thus serves as a fluid connection between the connection region 16 and the exhaust volume 44, particularly via the channel 18 in the first contact 12. Particularly, the first contact 12 and the second contact 14 are arranged at a distance to each other where it may be possible that an arc A is present is exhibited to the insulating gas present here, the arc A which may significantly add to an increase in pressure in the volumes 34, 44 due to its high temperature serving to expand and/or evaporate the insulating gas present. In this state, the gas cylinder volume 34 compresses insulating gas—which is a resistance to the drive device 6—and thus forces the insulating gas via the passage 36 and the connection region 16 where the arc A may be through the channel 18 and the outlet 20. In the exhaust volume 44 the compressed insulating gas can be received which thus is a support to the drive device 6, particularly when the pressure is increased from an arc A.

There is a plurality of another outlets 52 of the exhaust 40, each of which another outlet 52 is blocked at least in the closed position as shown in FIG. 1, but which is as well blocked in the first interim position as shown in FIG. 2. The plurality (e.g. 2, 3, 4, 5, 6 or more) of another outlets 52 is especially distributed circumferentially, the another outlets 52 which are referred to as ‘the another outlet 52’ in the following.

A surface 54 of the plunger 56 serves to block said another outlet 52. The surface 54 is shaped at least essentially cylindrically and extends in parallel to the switching axis 22 and/or the surface 47 of the exhaust 40. The surfaces 54, 47 face each other. The another outlet 52 closes the exhaust volume 44 to hold back the insulating gas and to have a pressure build-up so that the drive device 6 is supported. The another outlet 52 is in the form of radial hole comprising a size in the range of 1 to 100 mm.

Between the closed position and the open position and between the first interim position and the open position the first contact 12 assumes a second interim position as shown in FIG. 3. Here, the outlet 20 is fluidly connected to the exhaust volume 44 and is unblocked. In addition, the another outlet 42 fluidly connects the exhaust volume 44 with another volume of the circuit-breaker 1, e.g. the volume 4, and is unblocked. Thus, the cylinder volume 34 is connected to the outside of the making and breaking unit 10 so that the built-up pressure is at least partially released.

Upon a further movement of the first contact 12 towards the open position, the open position which is shown in FIG. 4, the side 13 and/or the part of the first contact 12 with the outlet 20 is retracted from the surface 46 of the exhaust 40 so that gas can even pass via the outlet 20 through either the another outlet 52 or a gap 58 formed between the first contact 12 and the exhaust 40.

The open position contains that the outlet 20 is unblocked, that the another outlet 52 is unblocked, and that the gap 58 is formed at the exhaust 40, cf. FIG. 4. The gap 58 is formed between the first contact 12 and the exhaust 40, particularly between the plunger 56 and the exhaust housing 42. The gap 58 has an annular shape.

This disclosure adopts the idea that initially closed volumes 34, 44 are designed to open at a certain stroke of the first contact 12. Initially, insulating gas is compressed in volume 34 while the volume 44 is increased in size, but not yet connected to volume 34. Then, the volumes 34, 44 are interconnected via the arcing region thereby building up support pressure of insulating gas particularly in the second volume 44 which serves as an assistance to the movement. Upon a further movement of the first contact 12 and/or a sufficient increase in pressure in volume 44, the volume 44 is designed to release the pressure. This is achieved by means of holes of proper areas positioned in proper sequence: first, outlets 20 in the first contact 12 contribute to the outflow of mechanically compressed, heated up and/or evaporated insulating gas to the volume 44; later the preferably larger another outlets 52 start contributing to the outflow area.

Preferably, the exhaust volume 44 is smaller than the cylinder volume 34 by at least the factor of two throughout the positions.

Particularly, in the closed position the exhaust volume 44 is substantially zero wherein the cylinder volume 34 is thus larger than the exhaust volume 44.

Particularly in the first interim position the cylinder volume 34 is larger than the exhaust volume 44 particularly by a factor between 1 and 1000.

Particularly in the second interim position the cylinder volume 34 is larger than the exhaust volume 44 particularly by a factor between 1 and 1000.

Particularly in the closed position the cylinder volume 34 is larger than the exhaust volume 44 particularly by a factor between 1 and 1000.

Particularly in the first interim position one or both of the volumes 34, 44 is/are larger than in the closed position particularly by a factor between 1 and 100.

Particularly in the second interim position one or both of the volumes 34, 44 is/are larger than in the first interim position particularly by a factor between 1 and 100.

Particularly in the closed position one or both of the volumes 34, 44 is/are larger than in the second interim position particularly by a factor between 1 and 100.

### REFERENCE SIGNS LIST

1 circuit-breaker
2 housing
4 volume
6 drive device
10 making and breaking unit
12 first contact
13 side
14 second contact
16 connection region
18 channel
19 face side
20 outlet
21 contact means
22 switching axis
24 moving distance
30 gas compression cylinder
32 cylinder element
34 cylinder volume
36 passage
40 exhaust
42 exhaust housing
44 exhaust volume
46 surface (of the exhaust and facing outlet)
47 surface (of the exhaust and with the another outlet)
48 piston
52 another outlet
54 surface (of the plunger and facing the another outlet
56 plunger
58 gap

1. A circuit-breaker for high-voltage applications comprising:
at least one making and breaking unit having a first contact and a second contact for forming an electrically conductive connection in a connection region, wherein the first contact has an outlet arranged distant to the connection region for insulating gas passing the connection region and through the first contact and wherein the first contact is movable along an axially extending switching axis of the circuit-breaker over a moving distance between a closed position where the electrically conductive connection is formed and an open position where the electrically conductive connection is separated which moving distance is between 10 and 500 mm;
a gas compression cylinder that is motion-coupled to the first contact and which defines a cylinder volume for the insulating gas, wherein the cylinder volume is variable by means of a piston sliding in the gas compression cylinder when moving the first contact, wherein the gas compression cylinder comprises a passage extending between the cylinder volume and the connection region; and
an exhaust for receiving the insulating gas through the outlet, defining an exhaust volume for received insulating gas, wherein the exhaust volume is variable by means of a plunger motion-coupled to the first contact,
wherein the exhaust is designed to increase the exhaust volume and the gas compression cylinder is designed to decrease the cylinder volume based on a separation movement of the first contact;
wherein another outlet of the exhaust for insulating gas passing the exhaust volume and the outlet are blocked at least in the closed position by means of the exhaust;
wherein the first contact can assume a first interim position between the open and the closed position, wherein in the first interim position the outlet is fluidly connected to the exhaust volume and the another outlet is blocked, and wherein the first contact is movable between the closed position and the first interim position by at least 1 mm or 5 mm; and
wherein the first contact can assume a second interim position between the first interim position and the open position where the another outlet fluidly connects the exhaust volume with another volume of the circuit-breaker and where the outlet is fluidly connected to the exhaust volume.

2. The circuit-breaker according to claim 1, wherein the outlet is blocked at least in the closed position by means of a surface of an exhaust housing, particularly the surface at least essentially extending in parallel to the switching axis and/or the outlet arranged on a side of the first contact.

3. The circuit-breaker according to claim 1, wherein in the first interim position the outlet is unblocked.

4. The circuit-breaker according to claim 1, wherein the another outlet of the exhaust is blocked in the first interim position, by means of the exhaust, or by a surface of the plunger, said surface at least essentially extending in parallel to the switching axis.

5. The circuit-breaker according to claim 1, wherein at the second interim position the outlet is unblocked, and/or the another outlet is unblocked.

6. The circuit-breaker according to claim 1, wherein the open position contains that the outlet is unblocked, that the another outlet is unblocked, and that a gap is formed at the exhaust.

7. The circuit-breaker according to claim 6, wherein the gap is formed between the first contact and the exhaust.

8. The circuit-breaker according to claim 1, wherein the exhaust volume is at least essentially smaller than the cylinder volume in at least one of said positions and/or by at least the factor of two, by one order of magnitude or more.

9. The circuit-breaker according to claim 1, wherein the exhaust is arranged distant to the connection region and/or opposite a face side of the first contact along the switching axis.

10. The circuit-breaker according to claim 1, wherein the exhaust housing is fixedly arranged relative to and/or formed with the second contact, the piston and/or a housing of the circuit-breaker.

11. The circuit-breaker according to claim 1, wherein the outlet and/or the another outlet are/is in the form of a radial hole and/or an oblong hole, comprising a size in the range of 1 to 100 mm.

12. The circuit-breaker according to claim 1, wherein the gas compression cylinder and/or the exhaust, at least partially surrounds and/or is coaxial to the first contact.

13. The circuit-breaker according to claim 1, the first contact having a channel extending from the connection region, the outlet extending from the channel to a side of the first contact, the outlet being arranged distant to the connection region and/or along the switching axis, and/or the outlet being shaped to be open at a face side of the first contact.

14. The circuit-breaker according to claim 1, wherein the exhaust, and the exhaust housing of the exhaust, surrounds the plunger for the plunger to slide on a surface of the exhaust, and/or wherein the plunger is fixedly arranged relative to the first contact.

15. The circuit-breaker according to claim 1, wherein the second contact has the shape of a pin in order to be plugged into the channel and/or a face side of the first contact and/or wherein at the connection region a passage of the gas compression cylinder extending from the cylinder volume is oriented oblique to the switching axis.

16. The circuit-breaker according to claim 1, wherein the gas compression cylinder surrounds and slides on the piston, wherein the piston surrounds and slides on the first contact, and/or wherein the piston is fixedly arranged relative to a housing of the circuit-breaker, the second contact, and/or the exhaust.

17. A method for building up support pressure in the circuit-breaker according to claim 1 that is being moved from a closed to an open position, comprising the step of:
compressing insulating gas in a cylinder volume and increasing an exhaust volume that is receiving the insulating gas having passed the connection region.
